(19) United States
(12) Patent Application Publication
(10) Pub. No.: US 2013/0046529 A1
(43) Pub. Date: Feb. 21, 2013

(54) Method and System for Classification of Clinical Information

(71) Applicants: Heather Mavis Grain, Malvern East (AU); Andrew Llewelyn Grain, Malvern East (AU)

(72) Inventors: Heather Mavis Grain, Malvern East (AU); Andrew Llewelyn Grain, Malvern East (AU)

(73) Assignee: Health Ewords Pty Ltd., Willoughby, New South Wales (AU)

(21) Appl. No.: 13/518,392

(22) PCT Filed: Dec. 21, 2010
(86) PCT No.: PCT/AU2010/001703

§ 371 Date: Sep. 12, 2012

(30) Foreign Application Priority Data
Dec. 22, 2009 (AU) 2009906210

(51) Int. Cl. G06F 17/28

(52) U.S. Cl. 704/2

(57) ABSTRACT

A method of translating clinical information into one or more standardised systems of coding or nomenclature processes received clinical information (202) relating to a patient, which includes at least one free text description of a clinical status of the patient. The free text description is analysed (208-218) to identify one or more terms relevant to the clinical status of the patient. One or more translation sets are constructed (220), each of which includes one or more sequential identified terms. Each translation set is translated (234-252) into one or more standardised health codes or terms selected from a predetermined system of classification and/or nomenclature, and the selected standardised health codes or terms are output (254). The method may be computer-implemented, either as a standalone program, or in a networked configuration supporting access from remote terminals.

### FIELD OF THE INVENTION

The present invention relates to the classification of clinical data. In particular, the invention provides a method and system for automating the translation of clinical information into relevant systems of coding or nomenclature based upon natural language input.

### BACKGROUND OF THE INVENTION

International classification of clinical data is important for gathering and maintenance of meaningful information regarding health, mortality and morbidity of populations. Such information may be used, for example, for the assessment and planning of health services, as well as for analysis of the health situation of population groups, monitoring of the incidence and prevalence of diseases, and the maintenance of records of individuals' health status, causes of death, and so forth.

The International Classification of Diseases (ICD), and national variations closely based thereon, is the most widely used statistical classification system for diseases. The ICD, currently at version 10 (ICD-10) is endorsed by the World Health Organisation (WHO), and is an international standard diagnostic classification for all general epidemiological, many health management purposes and clinical use. The ICD is used to classify diseases and other health problems recorded on many types of health and vital records, enabling the storage and retrieval of diagnostic information for clinical, epidemiological and quality purposes. These records also provide the basis for the compilation of national mortality and morbidity statistics by WHO Member States.

An issue that is closely related to the need for uniform classification of clinical data is the corresponding desirability for the use of consistent terminology, or nomenclature, for the storage and exchange of clinical information, particularly within computerised systems. For example, while terms such as “heart attack”, “myocardial infarction” and “MI” may all mean the same thing to a cardiologist, the use of a variety of different terminology for the same, or similar, conditions presents a problem for indexing, storage, retrieval and aggregation of clinical data.

A widely used system addressing the need for consistent use of terminology is the Systematised Nomenclature of Medicine-Clinical Terms (SNOMED-CT). SNOMED-CT is a systematically organised collection of medical terminology which covers most areas of clinical information, including diseases, findings, procedures, micro-organisms, pharmaceuticals and so forth. SNOMED-CT is designed to be computer-processable, and to provide a consistent system for indexing, storage, retrieval and aggregation of clinical data across specialities and sites of care.

While systems such as ICD and SNOMED-CT clearly address the need for uniform classification and nomenclature, they are extremely complex. For example, ICD-10 includes more than 187,000 codes, while SNOMED-CT consists of over a million medical concepts. While both systems are structured so as to facilitate their application, effective use requires substantial experience and expertise. Such complex systems are difficult and/or impractical to apply in “real world” health settings, such as hospitals and other points of care, where staff may be under considerable time and other pressures. In such environments, clinical information is generally entered into the relevant computerised record keeping systems in a natural language, or “free text” form.

Existing approaches to classification of clinical information collected within health care settings include subsequent review and manual coding by experts, the use of computerised indexes, search systems and browsers to assist users in the selection of relevant codes and terms, and encoding systems using “branching tree logic” (ie computerised systems that lead users through a series of questions designed to “converge” upon the most appropriate code or term).

Accordingly, there remains a need and a desire to substantially automate classification by providing a computerised system that is able to receive input at or from the point of care in a natural language or free text form, and process this information into one or more standardised coding or terminology systems, such as ICD-10 or SNOMED-CT. It is accordingly an object of the present invention to provide such a system.

### SUMMARY OF THE INVENTION

In one aspect, the present invention provides a method of translating clinical information into one or more standardised systems of coding or nomenclature, the method including:

receiving clinical information relating to a patient, said clinical information including at least one free text description of a clinical status of the patient;

analysing the free text description to identify one or more terms relevant to the clinical status of the patient;

constructing one or more translation sets, each translation set including one or more sequential identified terms;

translating each translation set into one or more standardised health codes or terms selected from a predetermined system of classification and/or nomenclature; and

outputting the selected standardised health codes or terms.

Advantageously, therefore, the method addresses the need for processing of free text (ie natural language) input in order to automate the process of classification of clinical information. A computer implementation of the method may readily be deployed in hospitals and other points of care, ie in real world health settings, to facilitate the gathering, indexing and storage of uniform information. Such a computerised system requires little or no specialised expertise by the operator in relation to the complex systems of coding and nomenclature employed.

In presently preferred embodiments of the invention, the standardised systems of coding and nomenclature are ICD-10 (and/or national variants) and SNOMED-CT. However, the invention is not limited to these particular systems, and it should be understood that the term “standardised”, in this context, refers to any agreed and/or widely adopted codification or nomenclature amongst relevant interested parties. In many cases, such standardised systems will be formally recognised or established international or national standards, however this is not necessarily the case.

In a preferred embodiment, the step of analysing the free text description includes assigning to each identified term one of a predetermined set of types, the assigned type being indicative of a function of the term within the free text description. In the embodiment described herein, the predetermined set of types includes “condition”, “treatment”, “body part”, “measure”, “agent”, “qualifier”, “severity”, “location”, “negation”, and “plurality”. The function of these different types will become apparent from the detailed description of the preferred embodiment which follows this summary of the invention. According to this embodiment, the different word types have a predetermined priority, or weighting, according to the foregoing order of listing, whereby eg “condition” words are of higher priority that “treatment” words, and so forth. Again, the significance of this approach will be more apparent from the detailed description.

Preferably, the received clinical information includes episode details and/or context information, in addition to the free text description. Episode details may include, for example, the age of the patient, sex of the patient, admission and/or discharge dates, discharge status (eg alive or dead), and (in the case of newborns) birth weight. The context may indicate speciality of the originator of the text, or field origin of the text. For example, context may include principal diagnosis field, emergency triage, obstetric observation, and/or the specialty where the patient was treated.

Advantageously, the provision of episode details may be used in the translating step to identify, for example, relevant age and/or sex appropriate codes or terms. Context may be used, for example, to disambiguate terms within the input text, such as abbreviations, that may have different meanings or nuances within different fields of speciality.

In a particularly preferred embodiment, the step of analysing further includes:

providing a word table including a set of recognised terms;

comparing each word in the free text description with the contents of the word table; and

in the event that the word corresponds with a recognised term in the word table, identifying the recognised term as relevant to the clinical status of the patient.

Advantageously, the word table may include synonyms for recognised terms, and in the event that a word in the free text description matches a synonym, the method includes identifying the corresponding recognised term as relevant to the clinical status of the patient. Synonyms may include not only different medical terms having the same meaning, but also common misspellings and typographical errors, in order to maximise the likelihood of identifying relevant terms within the free text input.

It is further preferred that the word table encodes hierarchical relationships between recognised terms, to enable substitution of more specific terms by more generic terms, where required. For example, the word “femur” may be encoded within the word table as being associated with the more generic term “leg”. Advantageously, the encoding of such hierarchical relationships within the word table facilitates effective translation of input text, for example when the operator enters a description including detail that is more specific than the corresponding relevant health codes or terms within the standardised systems.

The word table preferably also includes the predetermined type associated with each recognised term stored therein.

In accordance with the preferred embodiment, in the event that a word within the free text description does not correspond with a recognised term within the word table, the method may include storing the word and relevant context for subsequent manual review. Advantageously, the result of such a manual review may be the improvement and/or extension of the word table. For example, a failure to find a relevant match may result from the use of a term, or a misspelling, that had not previously been observed or encountered. Such words may then be added to the word table, either as synonyms or as new recognised terms, as appropriate.

In accordance with the preferred embodiment, the step of constructing one or more translation sets includes constructing each translation set such that no two terms thereof have the same assigned type. In particular, an exemplary method of constructing translation sets includes the steps of:

creating a new empty translation set;

populating the new translation set by adding sequential terms in association with their corresponding assigned type, until a term is encountered having the same assigned type as a term previously added to the set; and

repeating the creating and populating steps until all identified terms have been allocated to a translation set.

Preferably, after creating a new translation set in response to encountering a term having a repeated type, any terms in the prior translation set having a higher priority are initially copied into the new translation set.

In the preferred embodiment, the step of translating each translation set into one or more standardised health codes or terms includes:

providing a translation table including a set of translations between recognised translation sets and corresponding standardised health codes or terms selected from the predetermined system of classification and/or nomenclature;

comparing each translation set with the contents of the translation table; and

in the event that the translation set corresponds with a recognised translation in the translation table, translating the translation set into the corresponding standardised health codes or terms.

In accordance with the preferred embodiment, in the event that a translation set does not correspond with a recognised translation in the translation table, the method includes attempting to replace one or more terms in the translation set with a corresponding more generic term, and comparing the resulting translation set with the contents of the translation table. As previously discussed, the replacement of specific terms with more generic terms may be implemented by encoding hierarchical relationships between recognised terms within the word table.

In the event that the translation set still does not correspond with a recognised translation in the translation table, the method may include a further step of reducing the size of the translation set by removing at least one term identified as being of lowest significance amongst the terms of the translation set, and comparing the resulting translation set with the contents of the translation table. Preferably, significance of each term is determined in accordance with the priority of the corresponding word type such that, eg a term of type “location”, “negation” or “plurality” is considered of lower significance than a term of type “condition”, “treatment” or “body part” (and so forth). However, it will be appreciated that this is not the only possible approach and, for example, identifying terms of least significance may be facilitated by encoding within the word table a suitable significance weighting in association with each word.

In the event that, after following all available strategies, the translation set still does not correspond with a recognised translation within the translation table, the relevant information (eg the received clinical information, and relevant results of the analysis and translation steps) may be stored for subsequent manual review, which may enable identification of the reasons for failure to find a recognised translation within the translation table, and subsequent improvement and/or extension of the table.

In a particularly preferred embodiment, the translation table contains multiple translations for one or more recognised translation sets, each being associated with a particular context, and a selection between the multiple translations is based upon context information included in the received clinical information. Advantageously, this facilitates the implementation of context-dependent translations, for example where terminology may have different meanings, or the most relevant standardised classification may depend upon the particular area of specialty where the patient was treated, or other aspects of the relevant context.

Preferably, embodiments of the invention include the further step of identifying semantic relationships between groups of two or more terms within the identified terms relevant to the clinical status of the patient. In particular, this may include replacing semantic groups of terms with a single corresponding term. Such a method preferably includes the steps of:

providing a semantic relationships table, including a set of recognised semantic groups associated with corresponding replacement terms;

comparing groups of terms within the identified terms relevant to the clinical status of the patient with the contents of the semantic relationships table; and

in the event that a group of terms corresponds with a semantic group in the semantic relationships table, replacing the group of terms with the corresponding replacement term.

Preferred embodiments of the invention provide further processing of the translated health codes or terms. For example, the step of translating preferably includes further processing of an initial set of standardised health codes or terms based upon episode details included in the received clinical information. This may include further translating one or more initial codes or terms to corresponding replacement codes or terms based upon the episode details, such as age and/or sex of a patient. Preferably, this is achieved by providing an age/sex rules table, including a set of translations between relevant initial codes or terms and corresponding replacement codes or terms in association with relevant age and/or sex information.

The step of translating may also include further processing an initial set of standardised health codes or terms representing a combination of multiple conditions to identify one or more replacement codes or terms that are more relevant to said combination. Preferably, this is achieved by providing a multiple rules table, including a set of translations between codes or terms representing a combination of multiple conditions, and corresponding replacement codes or terms relevant to said combination.

In another aspect, the invention provides a computerised system for translating clinical information into one or more standardised systems of coding or nomenclature, the system including:

a microprocessor;

at least one memory device, operatively coupled to the microprocessor; and

at least one input/output peripheral interface, operatively coupled to the microprocessor,

wherein the memory device contains executable instruction code which, when executed by the microprocessor, causes the system to implement a method including the steps of:
receiving, via the input/output peripheral interface, clinical information relating to a patient, said clinical information including at least one free text description of a clinical status of the patient;
analysing the free text description to identify one or more terms relevant to the clinical status of the patient;
constructing one or more translation sets, each translation set including one or more sequential identified terms;
translating each translation set into one or more standardised health codes or terms selected from a predetermined system of classification and/or nomenclature; and
outputting, via the input/output peripheral interface, the translated standardised health codes or terms.

Is some embodiments, the system may be a standalone computer-based system, such as a software application executing on a personal computer, wherein the input/output peripheral interface includes user input/output devices, such as a keyboard, mouse, display and/or printer, and the computer executable instruction code includes instructions causing the system to implement a user interface via the user input/output devices.

In alternative embodiments, the computerised system may be network-based, enabling remote access, eg via the Internet, and the input/output peripheral interface may include a network interface, wherein the computer-executable instruction code includes instructions causing the system to receive the clinical information, and to output the translated health codes or terms, via the network interface. Such a network system may be web-based, including a suitable interface enabling individual entry of clinical information, and/or may support uploading, translation and downloading of clinical information and corresponding classification information in bulk.

Further preferred features and advantages of the present invention will be apparent to those skilled in the art from the following description of a preferred embodiment of the invention, which should not be considered to be limiting of the scope of the invention as defined in any of the preceding statements, or in the claims appended hereto.

### BRIEF DESCRIPTION OF THE DRAWINGS

A preferred embodiment of the invention is described with reference to the accompanying drawings, in which like reference numerals refer to like features, and wherein:

FIG. 1A is a block diagram illustrating a networked system for translating clinical information into one or more standardised systems of coding or nomenclature, according to an embodiment of the invention;

FIG. 1B is a block diagram illustrating a standalone system for translating clinical information into one or more standardised systems of coding or nomenclature, according to an embodiment of the invention;

FIG. 2 is a flowchart illustrating a method of translating clinical information into one or more standardised systems of coding or nomenclature, according to preferred embodiments of the invention;

FIG. 3 is a flowchart illustrating a preferred method of constructing translation sets, within the method illustrated by the flowchart of FIG. 2; and

FIGS. 4 to 10 show illustrative examples of translations of clinical information into ICD codes and SNOMED-CT nomenclature according to a preferred embodiment of the invention.

### DETAILED DESCRIPTION OF PREFERRED EMBODIMENTS

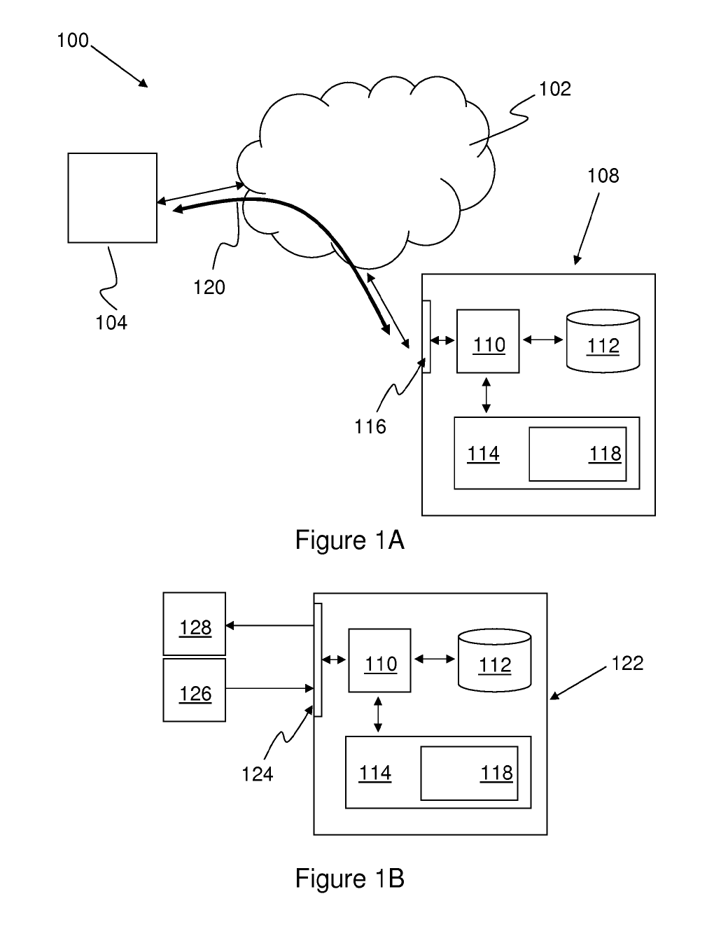

FIG. 1A is a block diagram illustrating a networked system 100 embodying the present invention. In this first exemplary embodiment, the system 100 is interconnected via the Internet 102, however it will be appreciated that alternative data communications networks, such as dial-up connections, or dedicated data links, may be employed. However, deployment via the Internet, or equivalent Wide Area Networks, is considered to be particularly advantageous, since it enables the benefits of the invention to be delivered remotely to a relatively large number of end-users.

The system 100 includes a user computer 104, which may be located at a hospital, a medical clinic, or other point of care. Appropriate software for the recording and maintenance of patient records is installed and executes on the user computer 104. As will be appreciated, a number of suitable software applications of this type are commercially available. Alternatively, or additionally, conventional web browser software executing on the user computer 104 may be used to access a web-based interface to a remote patient data system. In any event, the important characteristic of the user computer 104, for the purposes of illustrating the operation of embodiments of the present invention, is that it may be used by clinical staff or other operators at a point of care for the entry of clinical information relating to one or more patients.

A server computer 108 is accessible to the user computer 104, via the Internet 102. The server computer 108 includes at least one processor 110, which is interfaced, or otherwise operatively associated, with a high-capacity, non-volatile memory/storage device 112, such as one or more hard disk drives. The storage device 112 is used primarily to contain programs and data required for the operation of the server computer 108, and for the implementation and operation of various software components implementing an embodiment of the present invention. The means by which appropriate configuration of the server computer 108 may be achieved are well-known in the art, and accordingly will not be discussed in detail herein.

The server computer 108 further includes an additional storage medium 114, typically being a suitable type of volatile memory, such as Random Access Memory, for containing program instructions and transient data relating to the operation of the computer 108. Additionally, the computer 108 includes a network interface 116, accessible to the central processor 110, facilitating communications via the Internet 102.

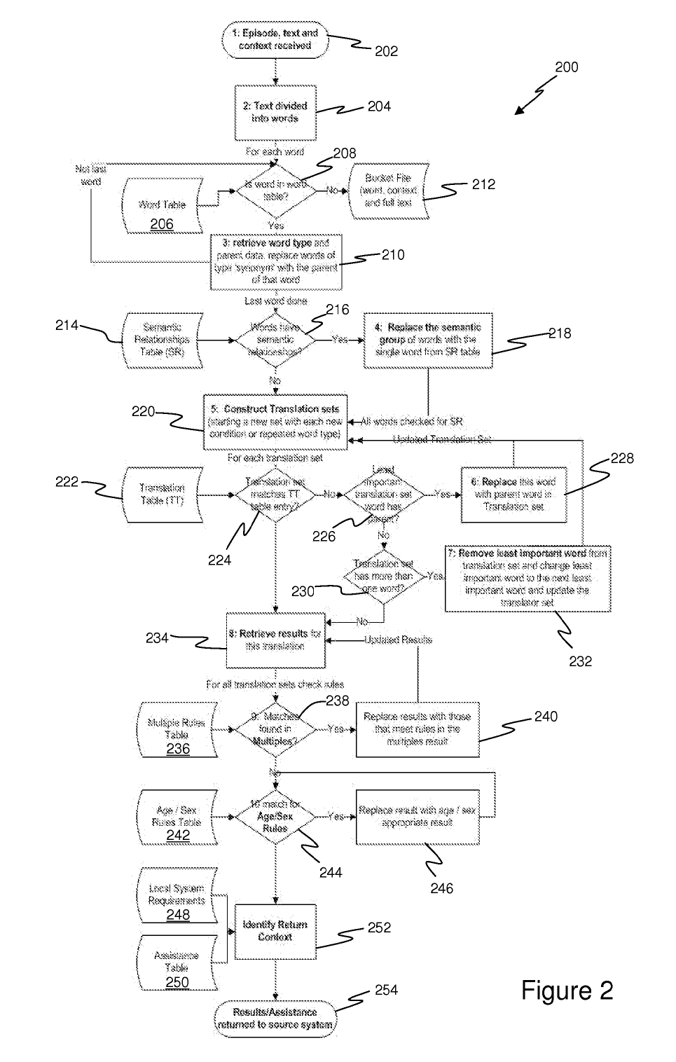

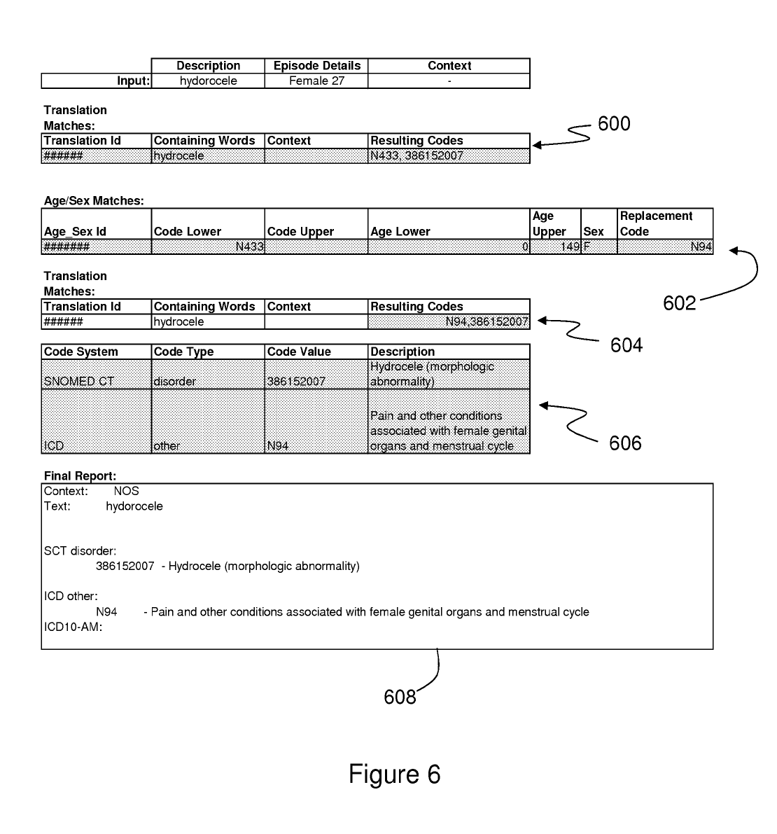

The memory device 114 contains a body of program instructions 118 embodying various software-implemented features of the present invention, as described in greater detail below with reference to FIGS. 2 to 10 of the accompanying drawings. In general, these features include data analysis and processing functions implementing a method of translating clinical information into one or more standardised systems of coding or nomenclature, more specifically being the International Classification of Diseases (ICD) and the Systematised Nomenclature of Medicine-Clinical Terms (SNOMED-CT) in the exemplary embodiment described herein.

Additionally, a network server application is implemented, such as a web server or the like, enabling the functions of the server computer 108 to be accessed via the Internet 102 from the user computer 104.

FIG. 1B is a block diagram illustrating an alternative embodiment which provides a standalone system for translating clinical information into standardised systems of coding or nomenclature. In this alternative embodiment, a standalone computer 122 is interfaced via suitable peripheral interface devices 124 to user input/output components. An input component 126 may include a keyboard, as well as a mouse or other pointing device. An output component 128 may include a visual display, and may also include a printer for generating hard copy output. The microprocessor 110, storage devices 112, 114, and executable program instructions 118 provide similar functionality, in relation to implementing a method embodying the present invention, as in the server computer 108 of the first embodiment 100. However, in the case of a standalone implementation, the body of program instructions 118 preferably also includes instructions implementing a suitable user interface, such as a graphical user interface, enabling a user to enter and retrieve information via the input/output peripheral components 126, 128. The general configuration of a standalone computer system, such as the computer 122, is well-known in the art, and therefore will not be described in greater detail herein.

Turning now to FIG. 2, there is shown a flowchart 200 illustrating a method of translating clinical information into one or more standardised systems of coding or nomenclature, in accordance with preferred embodiments of the invention. At step 202, clinical information relating to a patient is received. The received clinical information includes at least one free text (ie natural language) description of a clinical status of the patient. In preferred embodiments, the received clinical information also includes episode details and context information. Episode details are preferably received in Health Level 7 (HL7) format, which those skilled in the relevant art will recognise as a widely deployed standard format for the exchange, integration, sharing and retrieval of electronic health information, thereby maximising interoperability of the system. The context information is preferably received as an openEHR archetype uniquely identified field. Again, persons skilled in the relevant art will recognise that openEHR (Electronic Health Record) archetypes are widely implemented, thereby facilitating interoperability of the system.

As described in greater detail below, the primary function of preferred embodiments of the present invention is the translation of the free text description of clinical status of the patient into one or more standardised health codes or terms selected from a predetermined system of classification and/or nomenclature, such as ICD and/or SNOMED-CT. The episode details and context information also received in the exemplary embodiment may serve to assist and/or refine this task, as will also be described in greater detail below. Context information generally relates to the context in which the patient has been admitted and/or treated, such as a specialty area of treatment, or field origin of the descriptive text, for example principal diagnosis field, emergency triage, obstetric observation, and so forth. Preferably, episode details include some or all of the following information:
Episode Start Date, eg admission date;
Episode End Date, eg discharge date;
Patient ID, which uniquely identifies the individual patient in the source system;
Episode ID, which uniquely identifies the episode in the source system, enabling a final result to be returned to the correct patient's case;
Age and Age Type, which together define the patient's age in days, months or years;
Weight at Birth, which is required for episodes relating to newborns;
Sex, ie male, female, indeterminate or unknown; and
Discharge Type, ie alive or dead, which is a required field for newborns.

In preferred embodiments, the episode start and end dates may be relevant to determining the most appropriate coding in the final translation. For example, rules for coding can change according to the discharge date of the individual, and the length of stay (calculated from admission and discharge dates) may be used to determine codes assigned for day-only admissions.

At step 204 analysis of the free text description commences, by first dividing the text into separate words. Dividing points are determined by the presence of spaces, punctuation and/or other special characters in the text.

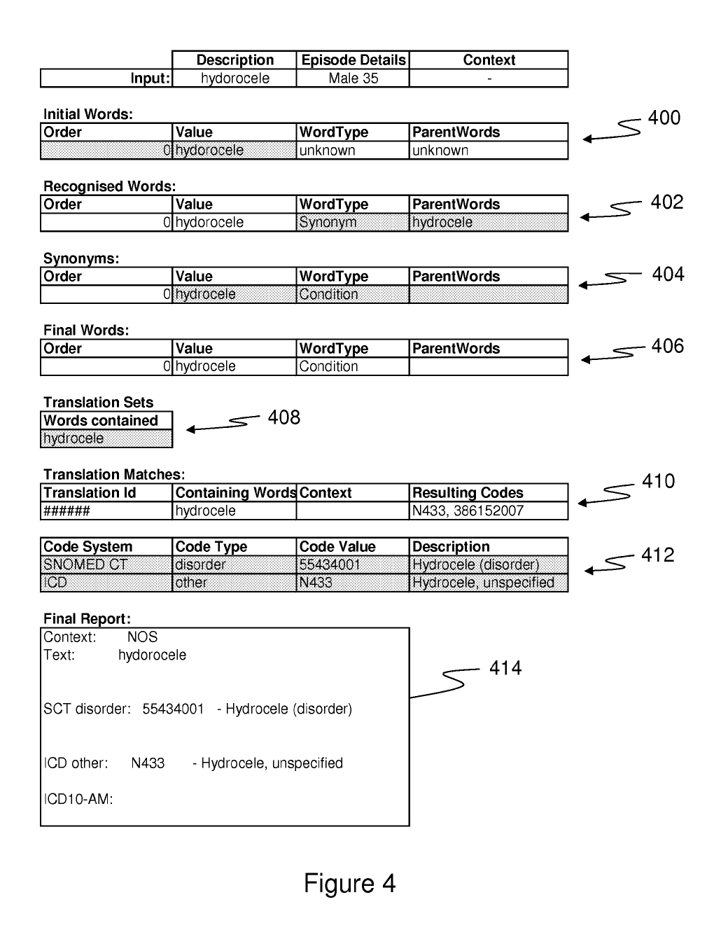

For the purposes of further analysis of the free text description, a Word Table 206 is provided, for example stored within a file, database, or similar structure within the non-volatile storage 112. Processing of the word list generated at step 204 is conducted at steps 208 and 210. In particular, for each word in the list a comparison is made 208 with words in the Word Table 206, and if the word is found relevant information is retrieved from the Word Table 206 at step 210. In particular, each word in the Word Table constitutes a recognised term that is relevant to the clinical status of the patient, and has a corresponding type associated with it in the Word Table 206. In accordance with the exemplary embodiment, the associated type is selected from the predetermined set including “condition”, “treatment”, “body part”, “measure”, “agent”, “qualifier”, “severity”, “location”, “negation”, and “plurality”. These different types have a predetermined priority, or weighting, according to the foregoing ordering, whereby “condition” terms are considered to be of highest priority, and “plurality” terms of the lowest priority. These types, and their corresponding priorities, play an important role in the translation process, as will become apparent from the further description below, and the various examples described with reference to FIGS. 4 to 10.

In accordance with the exemplary embodiment, an additional “pseudo-type” of “synonym” is also provided. A word of type “synonym” is replaced with an alternative identified word within the Word Table 206. Synonyms may be used to substitute words having the same meaning, in order to create more uniform input to the further stages of processing. Additionally, synonyms may be used as a means of correcting common spelling and/or typographical errors.

Additionally, the Word Table 206 encodes hierarchical relationships between recognised terms, to enable substitution of more specific terms by more generic terms, where required. That is, any word appearing in the Word Table 206 may be associated with a reference to a “parent” word, which is a corresponding more generic term. By way of example, a parent term for the word “femur” may be “leg”. In the preferred embodiment, this same referencing method is used to implement the synonym function, ie a word identified in the Word Table 206 as a “synonym” is replaced with the word identified as its parent.

Steps 208 and 210 are repeated until all words in the list of input free text words generated at step 204 have been processed. If at any stage during this processing, a suitable recognised term cannot be identified in the Word Table 206, then the word and relevant context (including the full descriptive text) are output to a file or other storage records 212, referred to in the exemplary embodiment as the “bucket file”. The contents of the bucket file may subsequently be reviewed manually, in order to identify those input words that could not be associated with recognised terms in the Word Table 206. These may include previously unencountered clinical and/or other descriptive terms, which may subsequently be added to the Word Table 206. Alternatively, these may include misspellings, abbreviations and/or typographical errors, which might be added as new synonyms within the Word Table 206.

Once all words have been processed, the final output from step 210 is a representation of the input free text that has been converted into a corresponding list of recognised terms from the Word Table 206. These terms are then further analysed through the use of a Semantic Relationships (SR) Table 214. Semantic relationships exist between groups of words which, when used together, have a particular meaning that may be better represented by a single word or term. One example of a semantic relationship is negation (eg non venomous) and other combinations of words that, when used together, result in a different meaning than the individual words taken separately. Semantic relationships can also be used to join common conditions in order to avoid the need to treat them as separate conditions during the subsequent translation steps.

Accordingly, at step 216 the recognised terms in the list output from step 210 are compared with word groupings appearing in the SR Table 214. Any matching semantic groups are replaced with a single word or term appearing in the corresponding entry in the SR Table, at step 218. This step can be iterated in order to check for further semantic relationships following replacements. Once all words have been checked for semantic relationships, and no further replacements are identified in the DR Table 214, control passes to step 220, at which one or more translation sets are constructed.

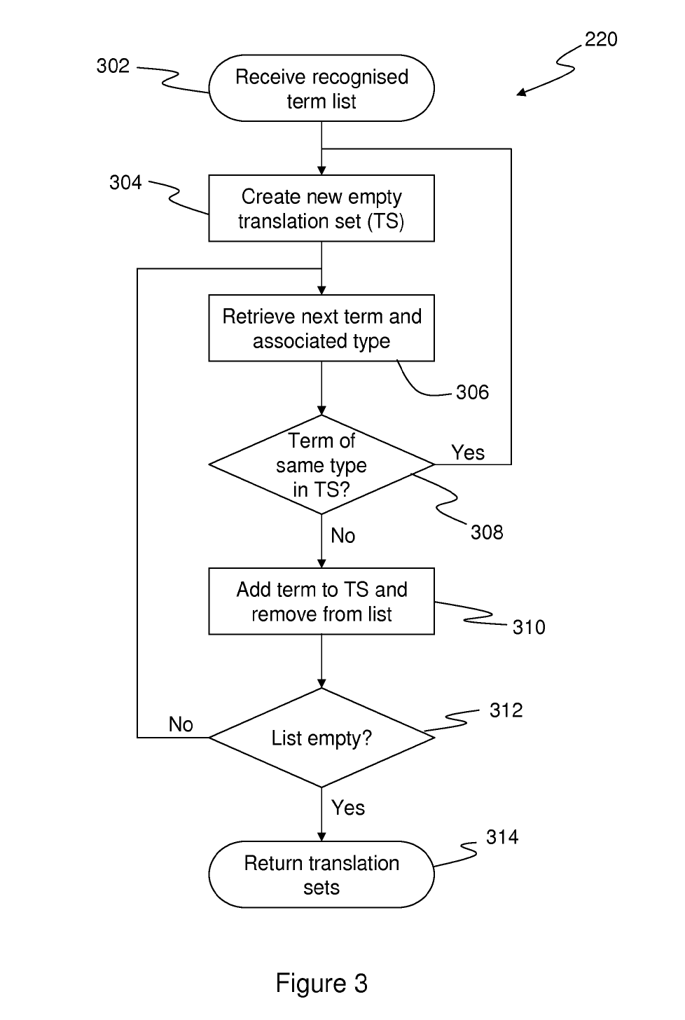

The process 220 for construction of translation sets is illustrated in greater detail in the flowchart shown in FIG. 3. At step 302, the list of recognised terms resulting from processing via the Word Table 206 and SR Table 214 is received. Initially, an empty Translation Set (TS) is created 304. A TS may be considered as a set of terms, each of which corresponds with one of the predetermined types described previously. While each TS need not contain terms of every available type, no more than one term of any given type may appear within a single TS.

Accordingly, TS construction proceeds as follows. At step 306, the next term and its associated type is retrieved from the input list. A check 308 is performed to determine whether or not a term having the same type has already been added to the current TS. If not, the new term is added to the TS, for example in a field corresponding with its associated type, at step 310, and processing then advances to the next term in the input list. However, if a term of the same type is already present in the current TS, the process returns to step 304, wherein a further new empty TS is created such that the term having duplicate type may be added to the new TS at step 306. Furthermore, any terms in the current TS that are of higher priority that the term which triggered creation of the new TS are initially copied into that new TS. The TS generation process continues in this manner until the test at step 312 determines that the terms in the input list have all been processed, at which point the group of newly generated translation sets is returned, at step 314.

The object of the next stage of the process is to translate each TS into one or more standardised codes or terms from the selected systems of classification and/or nomenclature, eg ICD-10 and/or SNOMED-CT. In order to achieve this objective, a Translation Table (TT) 222 is provided. The TT maps sets of terms/types (ie corresponding with possible translation sets) to corresponding sets of one or more codes from the relevant standardised system. For example, in the ICD-10 classification system, a particular set of terms may be mapped to one or more of a disorder code, a morphology code, a procedure code, a cause code, a location code, an activity code, and/or an other code. Within the SNOMED-CT system of nomenclature, a set of input terms may be mapped to one or more of a disorder code, a cause code, a location code, an activity code, a procedure code, and/or an other code. Each entry in the TT Table may have a particular context associated with it, in which case the context received at step 202 (ie as input to the overall translation process) must match.

At step 224 the method first seeks to identify an exact match within the TT. If no exact match is found, then the basic strategy for identifying the most relevant entry in the TT is as follows: firstly the process seeks to replace more specific terms with more generic terms before once again seeking a match in the TT; if no such replacements are possible, then the process seeks to remove the “least important” terms from the translation set, before again seeking a match in the TT. More specifically, at step 226 the least important term in the translation set (as determined by the relevant weighting or priority of the corresponding word type) is identified, and a check conducted to see if this term has a corresponding parent term in the Word Table 206. If so, then at step 228 the original term (ie more specific) is replaced with its parent (ie more generic). The updated TS is then passed back to step 224, for a further check against the TT 222. If the least important term cannot be replaced with a more generic substitute, control passes to step 230 which checks that there is more than one term remaining in the TS, and if so the least important word is removed, at step 232. Again, the updated TS is passed back to step 224 for further checking against the TT 222.

If no suitable match can be found in the TT after exhausting all available options, the relevant details of the input data and processing may be written to the bucket file 212 (connection not shown in flowchart 200). Additionally, it is possible to take into account the fact that more extensive processing of the TS in order to identify a suitable match within the TT 222 may be an indication of a less accurate or suitable translation of the input description into a corresponding set of codes from the standardised system. Accordingly, the preferred embodiment of the invention maintains a count or other record of the modifications made to the original TS in the course of identifying a match in the TT 222, which is a measure of “confidence” in the accuracy of the final translation. If an excessive number of updates to the TS are required, which number may, for example, be preset in the software and/or specified by the operator, the translation may be considered excessively unreliable, and again relevant information regarding the description which failed to produce a suitable translation may be written to the bucket file 212 for later analysis. Furthermore, in the event of a translation failure, the operator may be provided with an opportunity to enter an alternative description. In a further variation, the operator may be presented with the results of the attempted translation, in order to manually review the output. If the results appear to be acceptable, despite the low confidence level and/or number of updates to the TS, the operator will be able to accept the translation as being adequate.

Following translation, a number of further rules and transformations may be applied. One such rule relates to the handling of multiple conditions. In particular, specific systems of coding, classification and/or terminology may require that a single result is produced when certain combinations of conditions are present. For example, in the Australian variant of ICD-10 (ICD-10-AM) a single code is provided corresponding with the combination of asthma and Chronic Obstructive Airways Disease (COAD). As will be appreciated from the foregoing description, these two conditions will have been separated into distinct translation sets by process 220, and have been translated into their corresponding distinct codes via the TT 222. The Multiple Rules Table 236 includes the various rules for mapping combinations of conditions to single groups of coding results, where required. It should be noted that there are different circumstances in which the Multiple Rules Table may be applied, one being where specific rules of the coding system specify the production of a single result when certain combinations of conditions occur (such as the asthma and COAD example above), and the other being where there happens to be a code corresponding with a particular common combination of conditions (eg Diabetes Mellitus Type 2 with Retinopathy, in the ICD-10 coding system). Appropriate rules within the Multiples Table 236 can be used to handle either of these circumstances.

Specifically, at step 238 the encoded translation sets are checked against the Multiple Rules Table 236, and if any matching multiples are found these are replaced with the corresponding multiples result, at step 240. The updated results are then fed back through the process once again, until no further matching multiples are found. A further set of rules relates to results that may be age and/or sex specific. In order to handle such cases, an Age/Sex Rules Table 242 is provided, which includes appropriate mappings between particular result codes and age and/or sex dependent corresponding results. The Age/Sex Rules Table 242 may specify for each relevant input result/code a corresponding sex and age or age range, which maps to a new output result/code. At step 244 the identified codes are checked against entries in the Age/Sex Rules Table 242, and at step 246 any required replacements are made.

At least two additional sets of optional rules processing are not shown in the flowchart 200, which are only required in the case of death and/or newborns (age less than one year). In particular, in the case of death certain codes may require replacement, and a Death Rule Table, containing mappings between the original and replacement code/result, may be provided for this purpose. For newborns, relevant codes may be dependent upon birth weight, and a Weight Rule Table may be provided that includes mappings between original results/codes and replacement results/codes, based upon relevant ranges of birth weight.

Furthermore, there are cases in which the length of stay (ie the time between admission and discharge) may require that certain results/codes be replaced, and this may be implemented via a corresponding Length of Stay Rules Table.

Once all of the rules have been applied, a number of results/codes will have been assigned, each of which may need to be returned to a specific field recognisable at the source system, eg the computer 104 within the network system 100. In preferred embodiments, the system and method are adaptable to different source systems, and utilise local system requirements 248 and an Assistance Table 250 in order to identify an appropriate return context 252 so that the form and context of results returned to the source system at step 254 are appropriate. The local system requirements may include a context table, which identifies the unique field identifiers to be used for returning a given type of result in a given context. Rules may be provided for principal diagnosis and additional diagnoses, as well as for separation of results into the relevant fields for procedure, cause of injury, place of injury and activity during injury. It may be specified that results of a given type (eg procedure) are not required by the source system, so that even where such results are produced by the translation process, they are not returned to the source system. Local system rules may also be provided to determine which types of codes should be returned (eg ICD-10-AM, SNOMED-CT, and/or other classifications or nomenclatures that may be supported) and the format in which these should be returned.

The Assistance Table 250 may be used to specify whether, and what type of assistance should be returned along with the results. Assistance information may include the confidence counts discussed previously, as well as lists of potential additional codes that may be relevant. Such information may be used at the source system, eg computer 104, to present the operator with options to review, amend and/or reject the translation results.

Finally, at step 254, the results and additional information are converted into a standard HL7 message and returned to the source system 104.

While the foregoing provides a complete general description of the principals of operation of preferred embodiments of the present invention, a number of specific examples will now be described with reference to FIGS. 4 to 10, illustrating the operation of the system in response to particular inputs. It is intended that these examples will further clarify implementation details of a preferred embodiment of the invention, and illustrate the various capabilities and advantages thereof.

### Example 1

In this example, the input descriptive text is “hydorocele”, having associated episode details that the patient is a male, aged 35. The processing of this example is illustrated in FIG. 4.

An Initial Input Table 400 is formed, wherein each row corresponds with a word in the input text, and accordingly in this example the table contains only a single entry. In this case, the input “hydorocele” has been mistyped, and the correct spelling is “hydrocele”. This particular misspelling is included in the Word Table 206, and accordingly is associated with the type “synonym”, with the “parent” being the correctly spelled term. This first substitution, performed at step 208, is illustrated in the Table 402. Subsequently, replacement of the synonym occurs, and the correct entry in the Word Table 206 is identified, along with its associated type, ie “condition”, as shown in Table 404.

In this simple, single word, case there are no semantic relationships, and accordingly the final Word Table 406, passed to the translation set construction process 220, consists of the single word “hydrocele” having type “condition”. This results in a single translation set 408, also consisting of the single word “hydrocele”. In this case, there is an exact match in the Translation Table 222, for both ICD-10 (N433) and SNOMED-CT (386152007), as shown in the Table 410. Furthermore, in this example there are no multiples matches, and no applicable age/sex rules, and accordingly these codes represent the final results of translation, as shown in Table 412. A corresponding Final Report 414 may then be generated, and returned to the source system.

### Example 2

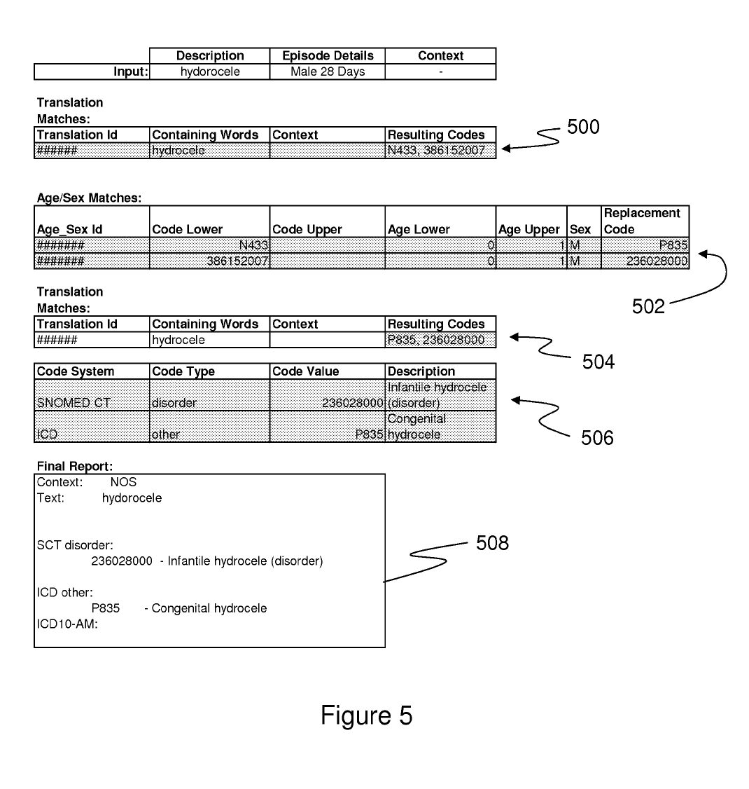

The second example has the same descriptive text input (“hydorocele”), however in this case the episode details include the information that the patient is a male aged 28 days (ie a newborn). This example, relevant portions of which are shown in FIG. 5, is a first illustration of the potential effect of application of age/sex rules. The initial steps in the translation process, resulting in translation matches shown in the Table 500, are identical with Example 1, and accordingly are not shown in FIG. 5.

Table 502 shows relevant entries in the Age/Sex Rules Table 242. In particular, the Table 502 shows that for the ICD code N433, and for males aged between zero and one years, the code should be replaced with P835. Similarly, for SNOMED-CT, the code 386152007 should be replaced with 236028000. It will be noted that the Age/Sex Rules Table 502 includes provision for a range of codes to be matched. In the present case the “Code Upper” field is not required, since a range does not apply.

The resulting age/sex rule translated matches are shown in Table 504, and the final itemised results in Table 506. A possible Final Report 508, returned to the source system, is also shown.

### Example 3

The third example is again based on the same descriptive text input as Examples 1 and 2, however in this example the episode details include the information that the patient is a female, aged 27. This example serves to further illustrate the application of the Age/Sex Rules Table 242. Once again, the translation matches resulting from the initial steps of the process 200 are identical with the previous two examples, as shown in the Table 600.

A relevant excerpt from the Age/Sex Rules Table 242 is shown in the Table 602, in which the ICD code N433 is required to be replaced with the code N94 in the case of a female patient aged between zero and 149 years (ie effectively of any age).

The resulting replacement matches are shown in the Table 604, and the final results in the Table 608. Once again, a Report 610 is shown, as may be returned to the source system.

### Example 4

In the fourth example, the free text descriptive input is “fell down stairs at home and # nof”, wherein the episode details include the information that the patient is a male, age 35. It should be noted that the symbol “#” is a standard abbreviation for a fracture, while “nof” is a standard abbreviation for “neck of femur”. These abbreviations are so common that they are recognised by the system, ie included as entries in the Word Table 206, in their own right, and not as abbreviations or synonyms.

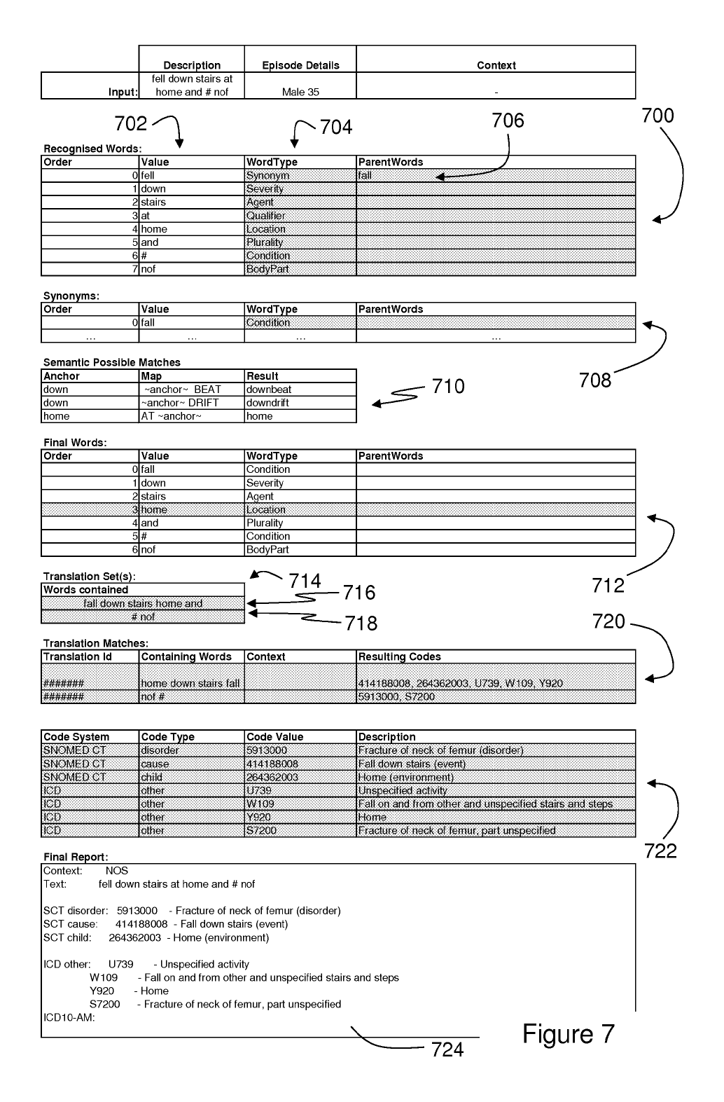

The results of division of the input text into words, and the initial pass through the word table, are shown in the Table 700 of FIG. 7. The column 702 shows the separated input description words, while the column 704 shows the associated types identified for those words in the Word Table 206. As can be seen, the word “fell” is identified in the Word Table 206 as a synonym for “fall”, as shown in row 706 of the Table 700. This word is thus further translated through the Word Table 206, such that “fell” is replaced with “fall”, which has the type “condition”. This is illustrated in the partial table 708, from which the unchanged entries have been omitted.

In this example, there are a number of possible semantic relationship matches in the SR Table as shown in Table 710. In particular, the word “down” has a different semantic meaning when it appears in combination with either of the words “beat” or “drift”. This is, however, not the case in this example. Relevantly, the word “home”, when proceeded by the word “at” results in a semantic relationship match whereby the phrase “at home” is replaced simply with the word “home”. In this case, since “home” is already assigned the type “location”, the “qualifier” word, ie “at”, carries no additional semantic meaning. Accordingly, the final set of words passed to the translation set construction process 220 is as shown in Table 712.

The results of translation set construction are shown in the Table 714. In this case, two separate translation sets are produced 716, 718. The first translation set includes the terms “fall down stairs home and”, while the second includes the term “# nof”. As will be seen from the Table 712, the second translation set commenced upon encountering the symbol “#”, which is the second term of type “condition” appearing in the final word list.

The results of translation via the Translation Table 222 are shown in the Table 720. There was no exact match in the Translation Table 222 for the translation set “fall down stairs home and”, and so the least significant word, being “and”, was removed. This resulted in a match with an entry containing the words “home down stairs fall”, having associated SNOMED-CT codes 414188008 and 264362003, and associated ICD codes U739, W109, and Y920. An exact match existed for the combination of “nof #”, corresponding with SNOMED-CT code 5913000, and ICD code S7200.

The final translation results are therefore shown in Table 722, and a potential report 724 may be generated for return to the source system.

This particular example may be adapted to illustrate the significance of associating priorities with different word types in the construction of translation sets. If the descriptive input had instead been “fell downs stairs at home and # nof and wrist”, a third TS would have been created. In particular, upon the term “wrist” would have been identified as a second term of type “body part” in the second TS (“# nof and . . . ”), whereby a third TS would be created. There being a term of higher priority present in the second TS, namely “#” of type “condition”, this would then be copied into the new TS, such that the final translation sets would be “fall down stairs home”, “# nof and” and “# wrist”. The system would thus ultimately correctly identify the two separate fractures resulting from the fall, and appropriate corresponding SNOMED-CT and ICD codes.

### Example 5

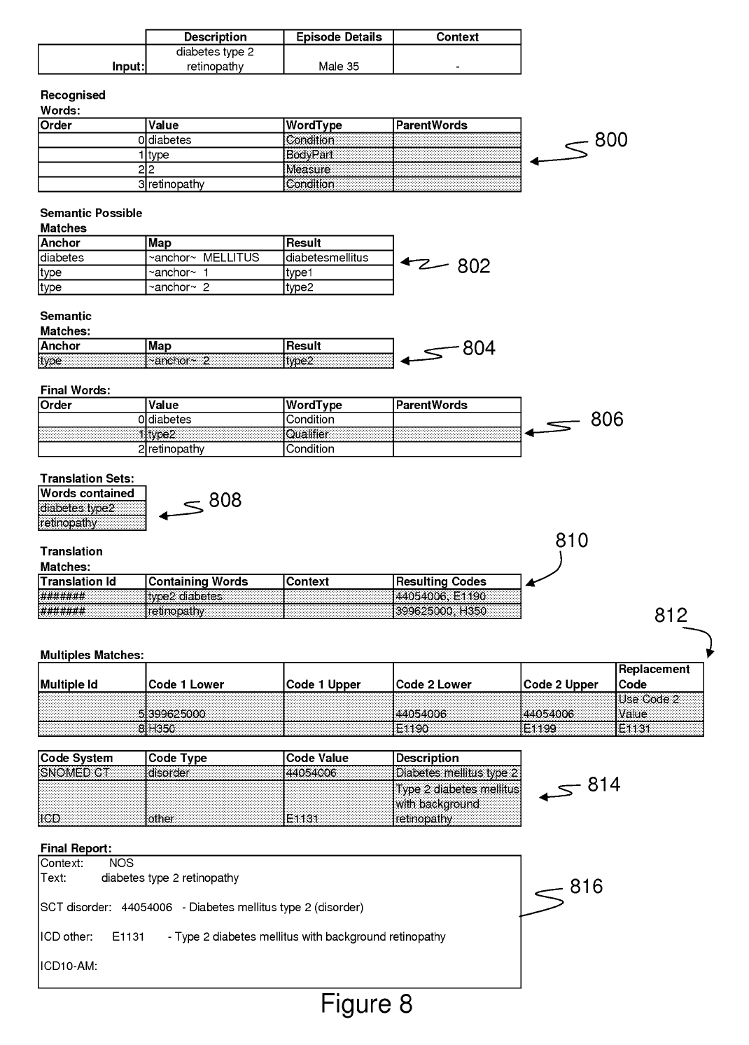

In the fifth example illustrated in FIG. 8, the input descriptive text is “Diabetes Type 2 Retinopathy”, and the episode details include the information that the patient is a male, age 35. The results of processing this input via the Word Table 206 are shown in the Table 800.

In this example, semantic relationships are once again relevant. As shown in Table 802, the SR Table includes three potentially relevant entries. Only one of these is applicable to the present case, namely that where the word “type” precedes the number “2”, this is replaced with the single identifying term “type2”, as shown in the final Semantic Matches Table 804. The final word list for further processing is therefore as shown in the Table 806.

In this case, two translation sets are constructed, as shown in Table 808, namely “diabetes type2”, and “retinopathy”. Each of these results then produces matches in both the SNOMED-CT and ICD systems, as shown in the Table 810.

However, this example illustrates the application of the Multiple Rules Table 236. Relevant entries within the Multiple Rules Table 236 are shown in the Table 812. In particular, when the SNOMED-CT code 399625000 occurs in combination with the code 44054006, as in this case, only the single code 44054006 should be returned. Within the ICD system, when the code H350 occurs in combination with the code E1190, then the code E1131 should be returned instead of the two input codes. As can be seen from the columns of the Table 812, the Multiple Rules Table 236 includes the facility to perform matching over ranges of first and second codes, where appropriate. In this particular example, any ICD code in the range E1190 to E1199, in combination with H350, would have been replaced with E1131.

The final returned code values are shown in the Table 814, and a potential output report 816 may be generated for return to the source system.

### Examples 6 & 7

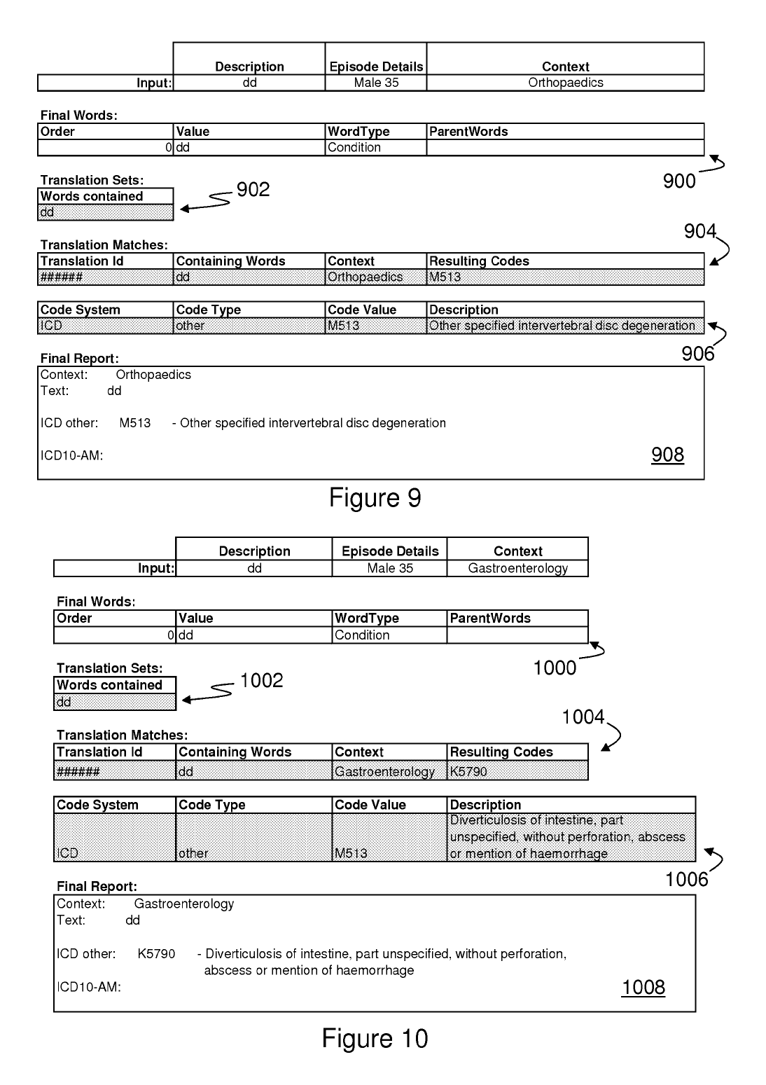

The final two examples illustrate the importance of context, and relevant results are shown in FIGS. 9 and 10 respectively. In both cases, the input descriptive text is simply “dd”, and the episode details include the information that the patient is a male, age 35. However, in Example 6 (FIG. 9) the context is “orthopaedics”, while in Example 7 (FIG. 10) the context is “gastroenterology”.

In both cases, the abbreviation “dd” is found in the Word Table 206, and has an associated type of “condition”, as shown in the respective tables 900, 1000. In both cases also, the same single translation set 902, 1002 is produced. However, when translating these terms through the Translation Table 222, it is necessary not only to match the term “dd”, but also the relevant context, ie orthopaedics or gastroenterology, and in this case there are different matching translation table entries, as shown in the Tables 904, 1004. Specifically, within the context of orthopaedics the term “dd” translates into the ICD code M513, reflecting the fact that within the field of orthopaedics the abbreviation “dd” refer to disc degeneration. In the context of gastroenterology, the appropriate ICD code is K5790, reflecting the fact that in this speciality the abbreviation “dd” relates to diverticulosis. In each of the Examples 6 and 7, therefore, different output codes are produced, as shown in Tables 906, 1006 respectively, and different output reports 908, 1008 may be generated.

### CONCLUSION

As will be appreciated from the foregoing description of preferred embodiments, and associated examples, implementations of the present invention are able to provide a powerful automated tool for the translation of natural language descriptions of clinical information relating to patients into one or more standardised systems of coding or nomenclature. Advantageously, information entered by frontline operators at hospitals and other points of care may be converted into standardised coding and terminology systems, for statistical, reporting and other purposes, with little or no further expert intervention. This may serve to significantly reduce the recording and reporting burden upon health care facilities, and to increase the uniformity of information capture.

While the foregoing description has covered various exemplary features of a preferred embodiment of the invention, it will be appreciated that this is not intended to be exhaustive of all possible functions provided within various embodiments of the invention. It will be understood that many variations of the present invention are possible, and the overall scope is as defined in the claims appended hereto.

1. A method of translating clinical information into one or more standardised systems of coding or nomenclature, the method including:
receiving clinical information relating to a patient, said clinical information including at least one free text description of a clinical status of the patient;
analysing the free text description to identify one or more terms relevant to the clinical status of the patient;
constructing one or more translation sets, each translation set including one or more sequential identified terms;
translating each translation set into one or more standardised health codes or terms selected from a predetermined system of classification and/or nomenclature; and
outputting the selected standardised health codes or terms.

2. The method of claim 1 wherein the step of analysing the free text description includes assigning to each identified term one of a predetermined set of types, the assigned type being indicative of a function of the term within the free text description.

3. The method of claim 2 wherein the received clinical information includes episode details and/or context information, in addition to the free text description.

4. The method of claim 3 wherein the episode details is selectively used in the translating step to identify relevant age and/or sex appropriate codes or terms.

5. The method of claim 3 wherein the context is selectively used to disambiguate terms within the input text that may have different meanings or nuances within different fields of speciality.

6. The method of claim 1 wherein the step of analysing further includes:
providing a word table including a set of recognised terms;
comparing each word in the free text description with the contents of the word table; and
in the event that the word corresponds with a recognised term in the word table, identifying the recognised term as relevant to the clinical status of the patient.

7. The method of claim 6 wherein the word table includes synonyms for recognised terms, and in the event that a word in the free text description matches a synonym, the method includes identifying the corresponding recognised term as relevant to the clinical status of the patient.

8. The method of claim 6 wherein the word table encodes hierarchical relationships between recognised terms, to enable substitution of more specific terms by more generic terms.

9. The method of claim 6 wherein the word table includes the predetermined type associated with each recognised term stored therein.

10. The method of claim 6 wherein, in the event that a word within the free text description does not correspond with a recognised term within the word table, the method includes storing the word and relevant context for subsequent manual review.

11. The method of claim 1 wherein the step of constructing one or more translation sets includes constructing each translation set such that no two terms thereof have the same assigned type.

12. The method of claim 11 wherein constructing translation sets includes the steps of:
creating a new empty translation set;
populating the new translation set by adding sequential terms in association with their corresponding assigned type, until a term is encountered having the same assigned type as a term previously added to the set; and
repeating the creating and populating steps until all identified terms have been allocated to a translation set.

13. The method of claim 1 wherein the step of translating each translation set into one or more standardised health codes or terms includes:
providing a translation table including a set of translations between recognised translation sets and corresponding standardised health codes or terms selected from the predetermined system of classification and/or nomenclature;
comparing each translation set with the contents of the translation table; and in the event that the translation set corresponds with a recognised translation in the translation table, translating the translation set into the corresponding standardised health codes or terms.

14. The method of claim 13 wherein, in the event that a translation set does not correspond with a recognised translation in the translation table, the method includes attempting to replace one or more terms in the translation set with a corresponding more generic term, and comparing the resulting translation set with the contents of the translation table.

15. The method of claim 13 wherein, in the event that a translation set does not correspond with a recognised translation in the translation table, the method includes reducing the size of the translation set by removing at least one term identified as being of lowest significance amongst the terms of the translation set, and comparing the resulting translation set with the contents of the translation table.

16. The method of claim 13 wherein, in the event that a translation set does not correspond with a recognised translation within the translation table, the relevant information is stored for subsequent manual review.

17. The method of claim 13 wherein the translation table contains multiple translations for one or more recognised translation sets, each being associated with a particular context, and a selection between the multiple translations is based upon context information included in the received clinical information.

18. The method of claim 1 including the further step of identifying semantic relationships between groups of two or more terms within the identified terms relevant to the clinical status of the patient.

19. The method of claim 18 including the steps of:
providing a semantic relationships table, including a set of recognised semantic groups associated with corresponding replacement terms;
comparing groups of terms within the identified terms relevant to the clinical status of the patient with the contents of the semantic relationships table; and
in the event that a group of terms corresponds with a semantic group in the semantic relationships table, replacing the group of terms with the corresponding replacement term.

20. The method of claim 1 including further translating one or more initial codes or terms to corresponding replacement codes or terms based upon episode details, such as age and/or sex of a patient.

21. The method of claim 20 including providing an age/sex rules table, including a set of translations between relevant initial codes or terms and corresponding replacement codes or terms in association with relevant age and/or sex information.

22. The method of claim 1 including further processing an initial set of standardised health codes or terms representing a combination of multiple conditions to identify one or more replacement codes or terms that are more relevant to said combination.

23. The method of claim 22 including providing a multiple rules table, including a set of translations between codes or terms representing a combination of multiple conditions, and corresponding replacement codes or terms relevant to said combination.

24. A computerised system for translating clinical information into one or more standardised systems of coding or nomenclature, the system including:
a microprocessor;
at least one memory device, operatively coupled to the microprocessor; and
at least one input/output peripheral interface, operatively coupled to the microprocessor,
wherein the memory device contains executable instruction code which, when executed by the microprocessor, causes the system to implement a method including the steps of:
receiving, via the input/output peripheral interface, clinical information relating to a patient, said clinical information including at least one free text description of a clinical status of the patient;
analysing the free text description to identify one or more terms relevant to the clinical status of the patient;
constructing one or more translation sets, each translation set including one or more sequential identified terms;
translating each translation set into one or more standardised health codes or terms selected from a predetermined system of classification and/or nomenclature; and
outputting, via the input/output peripheral interface, the translated standardised health codes or terms.

25. The system of claim 24 which is a standalone computer-based system, such as a software application executing on a personal computer, wherein the input/output peripheral interface includes user input/output devices, such as a keyboard, mouse, display and/or printer, and the computer executable instruction code includes instructions causing the system to implement a user interface via the user input/output devices.

26. The system of claim 24 which is network-based, enabling remote access, eg via the Internet, and the input/output peripheral interface may include a network interface, wherein the computer-executable instruction code includes instructions causing the system to receive the clinical information, and to output the translated health codes or terms, via the network interface.
